(19) United States
(12) Patent Application Publication
(10) Pub. No.: US 2010/0100444 A1
(43) Pub. Date: Apr. 22, 2010

(54) INTERNET PROTOCOL-BASED CONTENT DELIVERY TECHNIQUE

(76) Inventor: Keith Ball, San Jose, CA (US)

Correspondence Address: Robert D. Shedd, Patent Operations;THOMSON Licensing LLC, P.O. Box 5312, Princeton, NJ, 08543-5312, US

(21) Appl. No.: 12/451,194

(22) PCT Filed: May 4, 2007
(86) PCT No.: PCT/US07/10947

§ 371 Date: Oct. 29, 2009

(51) Int. Cl. G06Q 30/00; G06F 15/16

(52) U.S. Cl. 705/14.55; 705/14.58; 709/231

(57) ABSTRACT

To commence streaming of advertising clips to a player (22), the player provides its identity to a play list web site (24). In response, the play list web site downloads to the player at least one play list identifying at least one collection of advertising clips for streaming to the player. Using the play list, the player requests a content delivery network (12) to stream at least one collection of media clips.

### TECHNICAL FIELD

This invention relates to a method and apparatus for streaming audiovisual content such as advertising.

### BACKGROUND ART

Advances in the art of video compression and communications now makes it possible to distribute digital audiovisual content of a commercial nature, such as advertising, from one or more sources to a plurality of retail sites for viewing by customers. Many retailers have found that providing in-store advertising of this type in increased sales, justifying the time and expense associated with installation and maintenance of systems for providing such advertising, as well as on-going content subscription costs.

Presently, the providers of in-store audiovisual advertising often referred to as “Digital Signage” or “Out-Of-Home (OOH) advertising” must make use of specialized software and systems tailored for the delivery of such content. Such systems have included multicast file transfer servers that supply content for delivery via satellite or other dedicated channels. The specialized nature of such systems and software and the associated complexity and cost has limited the proliferation of such in-store advertising.

Thus, a need exists for a technique for delivering in-store audiovisual advertising content with reduced complexity and cost.

### BRIEF SUMMARY OF THE INVENTION

Briefly, in accordance with a preferred embodiment of the present principles, a method for remote in-store advertising commences by first receiving an identifier from a player located within an in-store advertising environment. Thereafter, at least one play list identifying at least one collection of media clips undergoes downloading to the player in accordance with the player identifier. Lastly, the at least one collection of media clips is streamed to the one player for replay in response to a request made by the player in accordance with the downloaded play list.

### BRIEF DESCRIPTION OF THE DRAWING

FIG. 1 depicts a block schematic diagram of an Internet-Protocol-based video network for distribution of one or more collections of media clips in accordance with the present principles.

### DETAILED DESCRIPTION

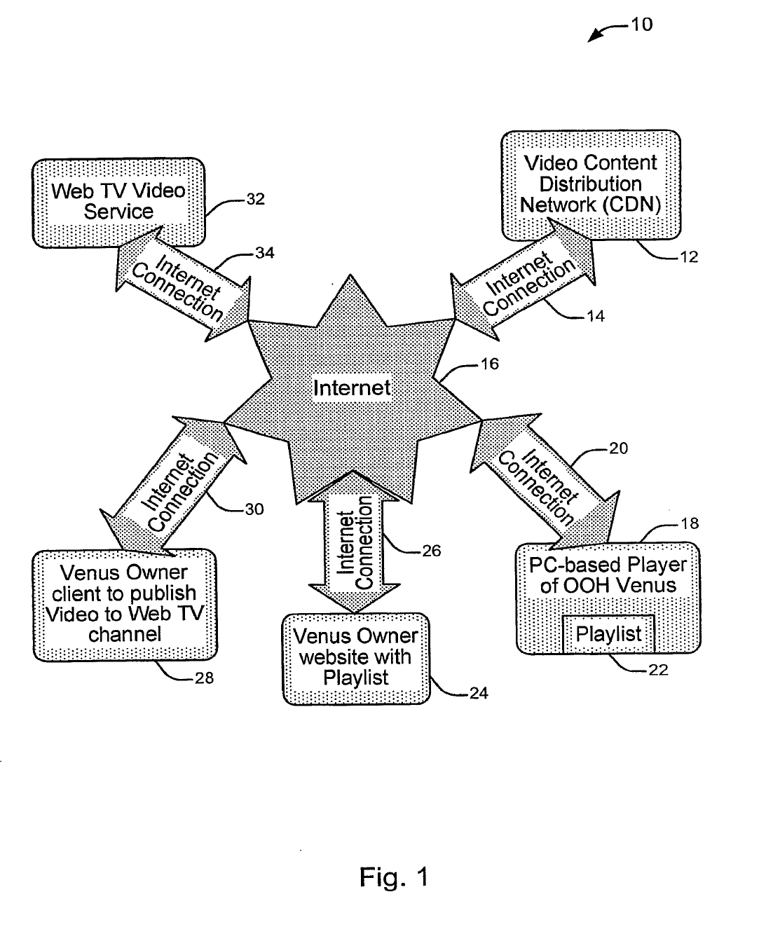

FIG. 1 depicts an Internet-Protocol-based system 10, for distributing content in the form of one or more collections of media clips in accordance with the present principles. The media clips within each collection typically comprise audiovisual programs (e.g., video clips with accompanying sound), which in the illustrated embodiment, take the form of advertising.

The collections of media clips undergo assembly at a Content Distribution Network (CDN) 12 linked via at least one IP channel 14 to a distribution network 16 that comprises a collection of interconnected computers publicly accessible through one or more service providers. Typically, the network 16 takes the form of the Internet, as currently constituted, although the network 16 could comprise a LAN, WAN or combination thereof, making use of wireless and/or wired connections, the later possibly including optical fiber links.

The CDN network 12 comprises one or more servers (not shown) that receive and store the media clips for assembly into one or more collections for distribution by streaming over the Internet 16 to at least one location 18, typically an in store environment, coupled to the Internet via an IP channel 20. While FIG. 1 depicts a single location 18 that receives at least one collection of media clips for playback, in practice, a plurality of locations could exist, each linked to the Internet 16 via one of more IP channels. The IP channel(s) that link each location 18 to the Internet 16 take the form of Web television (TV) channels. The establishment of such Web television channels, as well as their structure and operation are well known in the art.

In conventional IP-based video on-demand systems, the user drives the downloading process by requesting streaming of one or more media clips within a collection of such clips carried by a Web TV channel. The collection of clips in the Web TV channel is created on demand following a request by the user. Concurrent users will receive different streams, even if the users request the same clip. In this way, the Web TV channels differ from a centrally transmitted (e.g., uncasted) media stream provided by cable and broadcast TV operators.

Using one or more Web TV channels to deliver video on demand to viewers has proven effective. However, a typical video on-demand system that makes use of one or more Web TV channels heretofore has not proven effective for distribution of media clips for replay at a location, such as location 18, without operator intervention. In particular, the above-described conventional IP-based video on-demand system using one or more Web TV channels has not proven effective for enabling automated replay of different audiovisual advertisements for Out-Of Home advertising applications.

In accordance with an illustrative embodiment of the present principles, there is provided a content distribution and playback technique for using traditional IP-based video on demand principles for Out-Of Home advertising applications to enable automated replay of different advertisements. The content distribution and playback technique of the present principles makes use of at least one player 22 at each location that obtains through the IP channel 20 a collection of media clips for playback responsive to a request made by the player to the CDN 12. In practice, the player 22 takes the form of a computer, such as a conventional personal computer, running known operating systems, such as WINDOWS®, (a trademark of Microsoft Corporation) or MAC OS® (a trademark of Apple Computer), for example. In addition, the player 22 also runs software for media playback, such as “Flash 8” or the like. The player 22 displays the media clips on a display (not shown) which can include a television monitor or television projector, for example. Ancillary audio playback equipment (not shown) including an amplifier and one or more speakers can serve to playback embedded audio should the display lacks the ability to reproduce audio content. Although FIG. 1 depicts the presence of a single player 22 at the location 18, the location can include multiple players, with each served by at least one Web TV channel. In contrast to prior art in-store advertising systems that required the presence of large storage facilities, the player 22 need not possess large storage capacity since the advertising clips get streamed via the WEB TV channel. In this way, the overall cost of the player 22 can remain low, as compared to a player requiring a large storage capacity.

To facilitate replay of a collection of media clips containing advertising without operator intervention, the player 22, upon start-up, will launch a command by which the player specifies its identity for transmission to a play list website 24, linked to the Internet 16 via an IP channel 26. Typically, the web site 24 operates under the control of an entity (i.e., the venue owner) responsible for providing media (e.g., advertising) to each of the locations 18. In accordance with the identity information, the web site 24 will download to the requesting player 22 a play list that specifies one or more media clips within a collection for streaming to the player from the CDN 12. The player identity could comprise simply the identification of the location 18 in the event of a single player at the location 18. For locations having multiple players, the identity would include both the identity of the specific player and the player's location.

The play list downloaded to the player 22 not only specifies which media clips the player should receive, but the order in which such clips undergo playback. Thus, the play list provides a means for constructing specific sequences of media clips for individual locations 18. The web site 24 typically constructs the play lists in accordance with a master schedule, with target (location cluster) attributes assigned to the media clips. During generation of the play lists, various target attributes filter the master schedule of media clips. Some of the target attributes will remain while others will drop out. Ultimately, the web site 24 will distribute the play lists in accordance with the identity information as described previously.

Following receipt of the play list, the player 22 at the location 18 will then request one or more collections of media clips for streaming to the player from the CDN 12 in accordance with the play list. In other words, the player 22 will request the media clips specified in the play list from the CDN 12. The player 22 makes such a request in the same manner that a user requests media clips across a conventional Web TV channel. Thus, the same Web TV infrastructure currently in use for video on-demand can thus deliver advertising for Out-of-Home locations with very little complexity, as compared to present day OOH schemes.

To assure the ability to change and/or update the media clips (e.g., advertising) streamed to each location as well as the order which such clips undergo playback, each player 22 possess the ability to periodically request an updated play list. Alternatively, the web site 24 could periodically notify each player 22 of the availability of an updated play list for downloading.

In practice, the CDN 12 stores and assembles for delivery content (e.g., media clips) provided from another source, although the CDN could itself originate such content. In the illustrated embodiment of FIG. 1, the venue owner can maintain a separate web site 28, linked to the Internet 16 via an IP channel 30, for downloading content to the CDN 12. In a similar manner, a separate web site 32 can exist for providing the necessary hardware and software to operate, support and maintain the Web TV channels for content delivery.

The foregoing describes an IP-based video communications network.

1. A method for providing remote in-store advertising, comprising the steps of:
receiving an identifier from at least player located within an in-store environment;
downloading to the at least one player at least one play list identifying at least one collection of advertising clips for streaming to the one player in accordance with the player identifier; and
streaming to the at least one player for replay the at least one collection of advertising clips in response to a request made by the at least one player in accordance with the play list.

2. The method according to claim 1 wherein the identifier serves to identify player location.

3. The method according to claim 2 wherein the identifier serves to identify both player identity and player location.

4. The method according to claim 1 wherein the play list specifies playback order of the media clips in the collection.

5. The method according to claim 1 further including the step of periodically downloading additional play lists.

6. The method according to claim 1 further including the step of notifying the player of availability of an additional play list.

7. A method for playback of advertising by a player within an in-store environment, comprising the steps of:
providing an identifier that identifies the player within the in-store environment;
receiving at the player at least one play list identifying at least one collection of advertising clips for streaming to the player; and
requesting streaming to the player of the at least one collection of advertising clips.

8. The method according to claim 7 wherein the identifier serves to identify player location.

9. The method according to claim 8 wherein the identifier serves to identify both player identity and player location.

10. The method according to claim 7 wherein the play list specifies playback order of the media clips in the collection.

11. The method according to claim 7 further including the step of periodically receiving additional play lists.

12. The method according to claim 7 further including the step of receiving notification of availability of an additional play list.
